(19) United States
(12) Patent Application Publication
(10) Pub. No.: US 2001/0034643 A1
(43) Pub. Date: Oct. 25, 2001

(54) Method and system for advertising

(76) Inventor: John Acres, Corvallis, OR (US)

Correspondence Address: PERKINS COIE LLP, PATENT-SEA, P.O. BOX 1247, SEATTLE, WA, 98111-1247, US

(21) Appl. No.: 09/681,274

(22) Filed: Mar. 12, 2001

Related U.S. Application Data
(60) Provisional application No. 60/188,655, filed on Mar. 10, 2000.
(60) Provisional application No. 60/200,056, filed on Apr. 27, 2000.

(51) Int. Cl. G06F 17/60; A63F 9/24; A63F 13/00; G06F 17/00; G06F 19/00

(52) U.S. Cl. 705/14; 463/1

(57) ABSTRACT

A method and system for displaying advertisements to a user is provided. In one embodiment, the advertisement system downloads a collection of advertisements from an advertising server to the user's computer. When the user executes a computer program at the user's computer, the advertisement system displays the downloaded advertisements to the user. Thus, the advertisements can be displayed to the user even when the user's computer is not connected to the Internet.

### CROSS REFERENCE TO RELATED APPLICATIONS

This application is related to U.S. patent application Ser. No. 60/1 88,655, entitled “METHOD OF INDUCING PEOPLE TO VIEW ADVERTISEMENTS AND ACT UPON THEM WHILE PLAYING COMPUTER GAMES,” filed on Mar. 10, 2000 (Attorney Docket No. 336018001 US); and U.S. patent application Ser. No. 60/200,056, entitled “METHOD AND SYSTEM FOR ADVERTISING,” filed on Apr. 27, 2000 (Attorney Docket No. 336018001 US1), the disclosures of which are incorporated herein by reference.

### BACKGROUND OF INVENTION

The described technology relates in general to advertising and, more particularly, to displaying advertisements while a user interacts with a computer program.

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. The World Wide Web portion of the Internet is especially conducive to conducting electronic commerce. Many web servers have been developed through which vendors can advertise and sell product through a web site. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This order information may include the purchaser's name, the purchaser's credit card number, and a shipping address for the order. The server computer system then typically confirms the order by sending a confirming web page to the client computer system and schedules shipment of the items.

The profitability of an e-commerce web site depends in large part on the number of users who visit that web site. To encourage users to visit a web site, the web site may be advertised extensively. The web site may be advertised through traditional media, such as television, radio, and newspaper. The web site may also be advertised on web pages (e.g., via banner ads) generated by another web site. An advertiser may pay a displaying web site that displays their advertisement a certain amount each time that a user accesses a web page of the displaying web site that includes the advertisement. In addition, the advertiser may pay the displaying web site an additional amount each time a user clicks through the advertisement to access a web page of the advertised web site. Finally, the advertiser may pay the displaying web site a referral fee that is a percentage of the price of a purchase that resulted from the click through.

The displaying of advertisements can be very lucrative for a displaying web site. Indeed, some organizations may even pay users to browse the web while advertisements are displayed on a portion of user's display device. These organizations may collect demographic or other information about users so that the advertisements that are appropriate for each user can be selected. The organization may be compensated for each advertisement displayed, for each advertisement that is clicked through, and for each resulting transaction. Such organizations may also encourage users to refer friends and family to sign up with the organization. The referring user may be paid additional amounts if their referred friends and family browse the web while the organizations advertisements are displayed.

The compensation that a web site may receive for displaying an advertisement may be based in part on the perceived appropriateness of the advertisement to the user. For example, an advertisement for an automotive web site may not be appropriate for a ten-year old, but may be appropriate for a 21-year old. The advertisement for the automotive web site may be particularly appropriate to a 21 year old who has just purchased an automobile. Thus, an advertiser would be willing to pay more for advertisement whose appropriateness can be evaluated. Thus, to increase their revenues, organizations collect extensive information about users so that more appropriate advertisements can be presented to the users. The organizations may collect personal data such as age, occupation, gender, income, address, preferences, and shopping habits. These organizations may track the identity of a user using a sign on identification or a cookie stored on the user's computer. This information is so important that some organizations provide incentives (e.g., cash) for users to provide the information, which is then sold to other organizations.

Some web sites offer games (e.g., poker) that users can play to encourage users to visit the web site. As the users play the games, advertisements are displayed. Such gaming web sites may offer substantial prizes to encourage users to play the games and to provide personal information. These gaming web sites may even offer prizes to encourage users to click through the advertisements so that the gaming web site will receive a referral fee. Such gaming web sites can, of course, only be used while a user's computer is connected to the Internet.

It would be desirable to have a technique in which advertisements could be presented to a computer user even while the computer is not connected to the Internet.

### BRIEF DESCRIPTION OF DRAWINGS

FIG. 1 is a block illustrating the display of advertisements while a game is being played.

FIG. 2 is a block diagram illustrating the guiding of the user by an advertising server to web sites represented by selected advertisements.

FIG. 3 is a block diagram illustrating components used to implement the advertisement system in one embodiment.

FIG. 4 is a flow diagram illustrating the processing of the game program in one embodiment.

FIG. 5 is a flow diagram illustrating the processing of the launch advertisement window routine.

FIG. 6 is a flow diagram illustrating the processing of the display advertisement routine in one embodiment.

FIG. 7 is a flow diagram illustrating the processing of routine that is invoked when an advertisement in selected.

### DETAILED DESCRIPTION

A method and system for displaying advertisements while a user interacts with a computer program is provided. In one embodiment, the advertisement system downloads a collection of advertisements along with a computer game from an advertising server onto a user's computer system. When the user launches (i.e., starts the execution of) the computer game at the user's computer system, the advertisement system selects various advertisements from the collection of advertisements and displays the selected advertisements. Thus, the advertisements are displayed while the user plays the computer game that is executing on the user's computer. The advertisement system may change the displayed advertisements while the user plays the computer game. The advertisements may be selected randomly, selected based on user-specified preferences (e.g., to view advertisements related to automobiles), selected based on known characteristics (e.g., gender) of the user, or selected based on another criterion. For example, the advertisements may be selected based on the type of computer program with which the user is interacting or the particular capability of the computer program that is currently being used by the user. By downloading the collection of advertisements and the computer game, the user is able to play the computer game and view the advertisements without interacting with the advertising server or any other computer system. Thus, the advertisements can be displayed to the user even when the user's computer is not connected to the Internet.

In one embodiment, the user may select a displayed advertisement to indicate that the user would like to receive more information about the advertisement. The advertisement system tracks the user's selection of the advertisements. When the user's computer is subsequently connected to the advertising server via the Internet or any of the communications mechanisms, the advertisement system uploads the tracked selection of advertisements to the advertising server. The advertising server may then take the user on a tour of the web sites associated with the selected advertisements so that the user can view more detailed information relating to the advertisement. The advertising server may provide an incentive to the user to actually take the tour.

The advertisement system may provide an incentive (e.g., by providing a reward) for a user to play the game and view the advertisements. The user may be rewarded based upon the amount of time that the user spends playing the game. For example, the user may be paid $0.50 per hour for playing the game and viewing advertisements. Users may also be rewarded based upon the speed at which they complete their games. For example, a user who completes the game within the certain time period may receive an increased reward. The user may also be rewarded based upon the user's performance in comparison with other players. For example, a user who has one of the 10 highest scores or one of the longest winning streaks may receive an increased reward. As another example, rewards may be given as a “booby prize.” The rewards may include entry into a sweepstakes and free access to useful information (e.g., sports scores, trivia games, entertainment, news headlines, and so on). Additional rewards may be given when the user satisfies certain conditions, such as providing their demographic information (e.g., gender, age, education level, hobbies, and interests). Various techniques for providing rewards to users are described in U.S. patent application Ser. No. 09/782,942 (Attorney Reference No. 33601.8002US2), entitled “Method and System for Allocating and Redeeming Tokens,” filed on Feb. 14, 2001 which is hereby incorporated by reference. That reference describes that tokens, which can be exchanged for items of value, are allocated to users to provide an incentive to engage in certain activity.

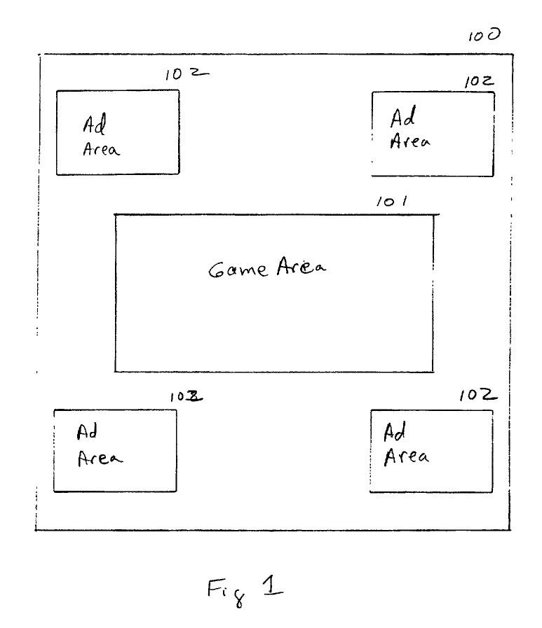

FIG. 1 is a block illustrating the display of advertisements while a game is being played. The display 100 displays a game area 101 and advertisement areas 102. The game area may be a window through which the user interface of the game is provided. The game may be any game that can be played on a computer system. For example, the game may be a card game (e.g., solitaire), a lottery game, a gambling-type game (e.g., roulette), Freecell, and so on. More generally, any type of computer program may be provided as a means of encouraging a user to use the computer and view the advertisements. For example, the computer program may be financial planning software or entertainment software, such as a program that displays a DVD movie. As discussed above, the computer program can be downloaded from the advertising server. Alternatively, the computer program can be one that is already stored on the user's computer. The advertisement system selects which advertisements should be displayed in the advertisement areas. The advertisement system may periodically replace the advertisements in the advertisement areas with new advertisements. A user may indicate an interest in receiving more information about an advertisement by selecting (e.g., clicking with a mouse) the advertisement area in which the advertisement is currently displayed. The advertisement system in one embodiment may have more detailed information about the advertisement stored at the user's computer. When the user selects an advertisement area, the advertisement system may display the more detailed information even though the computer is not currently connected to the Internet. The advertisement system may track the advertisements that are displayed to the user and may track those advertisements that are selected by the user. The advertising server may use the information about selected advertisements to provide more information to the user when the user eventually connects to the Internet. One skilled in the art would appreciate that the advertisement areas could be of any size, shape, location, time and number. Also, the advertisement area may contain advertisements only part of the time while the game is being played.

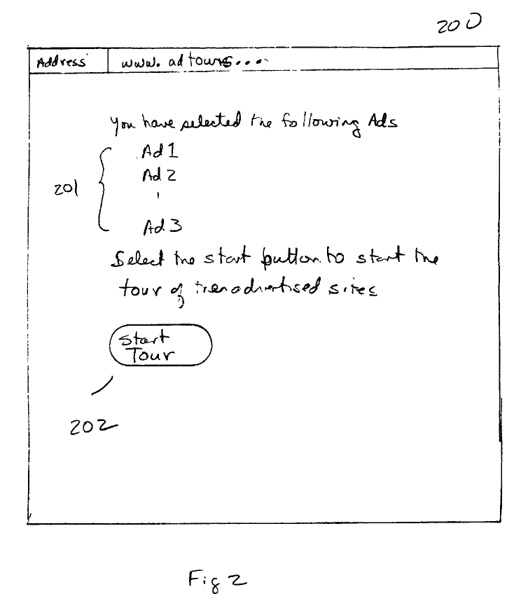

FIG. 2 is a block diagram illustrating the guiding of the user by an advertising server to web sites represented by selected advertisements. After a user connects to the Internet, the advertisement system uploads statistics about the game playing of the user to the advertising server. The advertising server can allocate tokens to the user as a reward and can allow the user to redeem the tokens. The advertising server provides an enhanced reward if the user tours web sites associated with the advertisements that were displayed while the game was played. The display 200 displays a browser window. The browser window indicates that the user selected advertisements 201 while playing the game. The user can select button 202 to start a tour of the web sites corresponding to the selected advertisements to review the additional information. Once the user selects the tour button, the advertising server coordinates the display of the web site associated with the first advertisement followed by the display of the web site associated with the second advertisement, and so on.

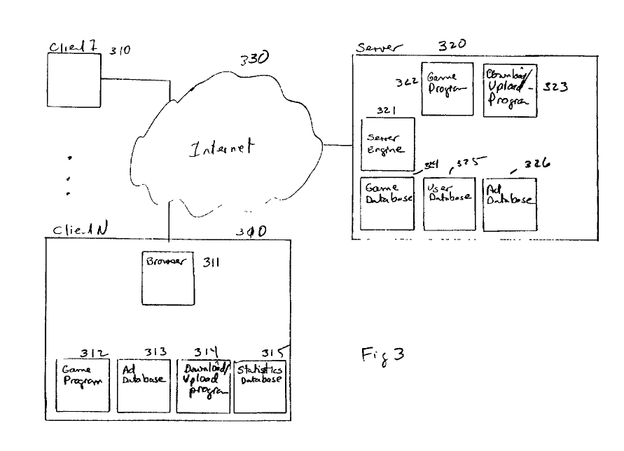

FIG. 3 is a block diagram illustrating components used to implement the advertisement system in one embodiment. The client computers 310 and the advertising server computer 320 are interconnected via the Internet 330. The computers may include a central processing unit, memory, input devices (e.g., keyboard and pointing devices), output devices (e.g., display devices), and storage devices (e.g., disk drives). The memory and storage devices are computer-readable media that may contain instructions that implement the advertisement system. In addition, the data structures and message structures may be stored or transmitted via a data transmission medium, such as a signal on a communications link. Various communications channels other than the Internet may be used, such as a local area network, a wide area network, or a point-to-point dial-up connection. Client 310 includes a browser 311, a game program 312, an advertisement database 313, a download/upload program 314, and a statistics database 315. The game program includes a game component for conducting the game and an advertisement component for coordinating the display of advertisements. The advertisement component selects the advertisements from the advertisement database and controls the display of the advertisements. The advertisement component may also update the statistics in the statistics database to indicate which advertisements were displayed to the user, which advertisements were selected by the user, the length of time that an advertisement was displayed, and so on. The advertisement component may also execute as a program that is independent of the game program. The download/upload program controls the downloading of advertisements from an advertising server and the uploading of statistics to the advertising server. The advertising server 320 includes a server engine 321, the game program 322, a download/upload program 323, a game database 324, a user database 325, and an advertisement database 326. The server engine receives HTTP requests and coordinates the sending of the HTTP response messages. The server engine may download any game program and the download/upload program to client computers when requested to do so using a web page provided by the advertising server. The statistic database contains statistical information about the advertisements that have been displayed to the users at the client computers. The user database contains information relating to each user who is registered to use the advertisement system. The advertisement database contains a collection of advertisements that are available to be downloaded to client computers for display.

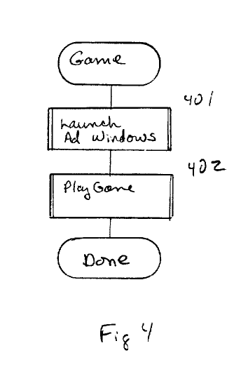

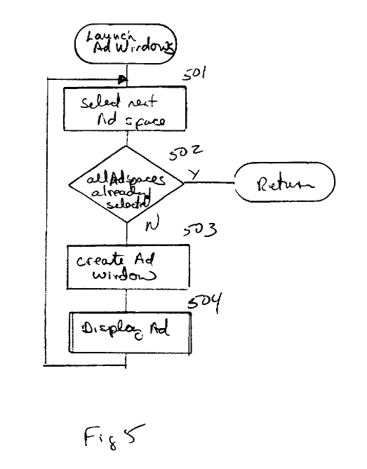

FIG. 4 is a flow diagram illustrating the processing of the game program in one embodiment. In this embodiment, the game program incorporates the functionality of playing the game and displaying the advertisements. In an alternate embodiment, the functionality of displaying the advertisements may be implemented in a program that is separate from the game playing program. In block 401, the game program launches the advertisement windows by invoking the routine illustrated in FIG. 5. This launching includes the creation of the windows in which the advertisements will be displayed and the displaying of the initial advertisements in the created windows. In block 402, the game program conducts the game.

FIG. 5 is a flow diagram illustrating the processing of the launch advertisement window routine. This routine creates a window for each advertisement area and displays an initial advertisement in the created windows. In block 501, the routine selects the next advertisements area. In decision block 502, if all the advertisement areas have already been selected, then the routine returns, else the routine continues at block 503. In block 503, the routine creates a new advertisement window. In block 504, the routine displays an advertisement in the created window and loops to block 501 to select the next advertisement area.

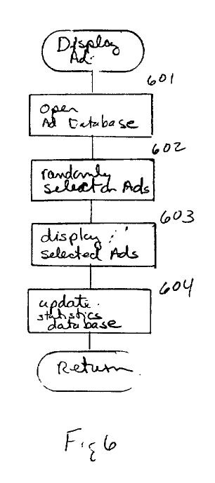

FIG. 6 is a flow diagram illustrating the processing of the display advertisement routine in one embodiment. This routine selects an advertisement and displays it in an advertisement area. In block 601, the routine opens the advertisement database. In block 602, the routine randomly selects an advertisement from the advertisement database. The advertisements that are stored on the user's computer may have been custom selected by the advertising server based on the characteristics (e.g., age, gender, occupation, and education) of the user. Alternatively, if the stored advertisements have not already been custom selected, then the custom selection can be performed by the user's computer, rather than randomly selecting an advertisement. In block 603, the routine displays the selected advertisement in an advertisement window. In block 604, the routine updates the statistics database to indicate the display of the selected advertisement and returns.

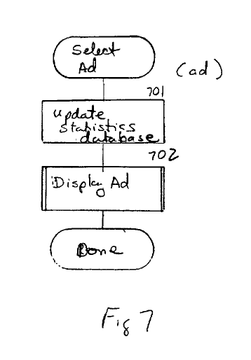

FIG. 7 is a flow diagram illustrating the processing of routine that is invoked when an advertisement in selected. In block 701, the routine updates the statistics database to indicate that the user has selected the advertisement. In block 702, the routine displays a new advertisement in the selected advertisement area and returns.

From the foregoing it will be appreciated that although specific embodiments of the technology have been described herein for purposes of illustration, various modifications may be made without deviating from the spirit and scope of the invention. For example, the user may be able to redeem tokens that have been allocated to the user at a redemption server that is separate from the advertising server. Also, the advertisement system may email statistics to the advertising server rather than or in addition to uploading the statistics when connected to the Internet. The advertisement system may output a selected advertisement in ways other than displaying advertisements on a display. For example, an advertisement may be output in an audio form. The technology can be used with personal computers, set top boxes, telephones, cell phones, video game devices, personal digital assistants, and so on. Accordingly, the invention is not limited except by the appended claims.

1. A method in a computer for displaying advertisements while a user plays a computer game, the method comprising:
receiving a collection of advertisements from a server computer via a communications link;
storing the received collection of advertisements;
starting execution of the computer game to be played by the user, the computer game to be executed by the computer;
while the user is playing the computer game,
selecting an advertisement from the stored collection of advertisements; and
displaying the selected advertisement so that the user can view the selected advertisement while playing the computer game.

2. The method of claim 1 including tracking when the displayed advertisement is selected by the user.

3. The method of claim 2 including sending to a server computer an indication that the advertisement was selected by the user.

4. The method of claim 1 including selecting another advertisement from the stored collection and displaying the selected other advertisement while the user is playing the computer game.

5. The method of claim 1 including rewarding the user based on time spent playing the game.

6. The method of claim 1 including rewarding the user based on speed at which the user completes the game.

7. The method of claim 1 including rewarding the user based on performance of the user at playing the game relative to performance of other users at playing the game.

8. A method in a computer for outputting advertisements while a user interacts with a computer program executing at the computer, the method comprising:
providing a collection of advertisements at the computer;
starting execution of the computer program on the computer; and
during execution of the computer program on the computer,
selecting an advertisement from the provided collection of advertisements; and
outputting the selected advertisement so that the user perceives the selected advertisement while interacting with the computer program.

9. The method of claim 8 including providing additional advertisements to the computer.

10. The method of claim 8 including:
during execution of the computer program on the computer,
selecting another advertisement from the provided collection of advertisements; and
outputting the selected other advertisement.

11. The method of claim 10 including storing indications of the output advertisements.

12. The method of claim 11 including sending to a server computer the stored indications.

13. The method of claim 8 including:
receiving from the user a selection of an output advertisement; and
storing an indication that the user selected the output advertisement.

14. The method of claim 13 including sending to a server computer the stored indication.

15. The method of claim 8 wherein the selection of the advertisement is based on a characteristic of the user.

16. The method of claim 8 wherein the provided collection is based on a characteristic of the user.

17. The method of claim 8 wherein the computer program is a game and including collecting statistics relating to the game.

18. The method of claim 17 including sending the collected statistics to a server computer.

19. The method of claim 8 wherein the computer program does not interact with another computer during its execution.

20. The method of claim 8 wherein the execution of the computer program and the selecting of the advertisement are independent of a server computer.

21. The method of claim 8 wherein the collection of advertisements is provided by a server computer.

22. The method of claim 8 wherein the selecting and outputting are under control of the executing computer program.

23. The method of claim 8 wherein the selecting and outputting are under control of another executing computer program.

24. The method of claim 8 wherein the outputting includes displaying the selected advertisement.

25. A method in a server computer for collecting information, the method comprising receiving indications relating to advertisements output while a user interacts with a computer program executing at a client computer, the indications being stored at the client computer while the client computer is offline from a network for connecting the client computer to the server computer.

26. The method of claim 25 wherein the indications indicate that the user selected an advertisement.

27. The method of claim 25 wherein the advertisements that are output are selected based on a characteristic of the user.

28. The method of claim 25 wherein the advertisements are provided to the client computer by another computer.

29. The method of claim 28 wherein the other computer is the server computer.

30. The method of claim 25 wherein the computer program is a game and including receiving indications relating to playing the game.

31. The method of claim 25 wherein the computer program does not interact with another computer during its execution.

32. The method of claim 25 wherein the client computer selects an advertisement independent of the server computer.

33. A computer-readable medium containing a data structure that includes indications relating to advertisements output while a user interacts with a computer program executing at a client computer, the indications being stored at the client computer while the client computer is not connected to the server computer.

34. The computer-readable medium of claim 33 wherein the indications indicate that the user selected an advertisement.

35. The computer-readable medium of claim 33 wherein the advertisements that are output are selected based on a characteristic of the user.

36. The computer-readable medium of claim 33 wherein the advertisements are provided to the client computer by another computer.

37. The computer-readable medium of claim 36 wherein the other computer is the server computer that receives the data structure.

38. The computer-readable medium of claim 37 wherein the computer program is a game and the data structure includes indications relating to playing the game.

39. The computer-readable medium of claim 33 wherein the computer program does not interact with another computer during its execution.

40. The computer-readable medium of claim 33 wherein the client computer selects an advertisement independent of a server computer.

41. A computer-readable medium containing instructions for controlling a computer to output advertisements while a user interacts with a computer program executing at the computer, by a method comprising:
providing a collection of advertisements at the computer;
starting execution of the computer program on the computer;
selecting an advertisement from the provided collection of advertisements; and
outputting the selected advertisement so that the user can perceive the selected advertisement while interacting with the computer program.

42. The computer-readable medium of claim 41 including providing additional advertisements to the computer.

43. The computer-readable medium of claim 41 including:
selecting another advertisement from the provided collection of advertisements; and
outputting the selected other advertisement.

44. The computer-readable medium of claim 43 including storing indications of the output advertisements.

45. The computer-readable medium of claim 44 including sending to a server computer the stored indications.

46. The computer-readable medium of claim 41 including:
receiving from a user selection of an output advertisement; and
storing an indication that the user selected the output advertisement.

47. The computer-readable medium of claim 46 including sending to a server computer the stored indication.

48. The computer-readable medium of claim 41 wherein the selection of the advertisement is based on a characteristic of the user.

49. The computer-readable medium of claim 41 wherein the provided collection is based on a characteristic of the user.

50. The computer-readable medium of claim 41 wherein the computer program is a game and including collecting statistics relating to the game.

51. The computer-readable medium of claim 50 including sending the collected statistics to a server computer.

52. The computer-readable medium of claim 41 wherein the computer program does not interact with another computer during its execution.

53. The computer-readable medium of claim 41 wherein the execution of the computer program and the selecting of the advertisement are independent of a server computer.

54. The computer-readable medium of claim 41 wherein the collection of advertisements is provided by a server computer.

55. The computer-readable medium of claim 41 wherein the selecting and outputting are under control of the executing computer program.

56. The computer-readable medium of claim 41 wherein the selecting and outputting are under control of another executing computer program.

57. The computer-readable medium of claim 41 wherein the outputting includes displaying the selected advertisement.

58. The computer-readable medium of claim 41 wherein the selecting and outputting are performed during execution of the computer program.

59. A system for outputting advertisements at a computer while a user interacts with a computer program executing at the computer, comprising:
means for storing a collection of advertisements at the computer;
means for executing the computer program;
means for selecting an advertisement from the collection of advertisements; and
means outputting the selected advertisement so that the user can perceive the selected advertisement while interacting with the computer program.

60. The system of claim 59 including means for providing additional advertisements to the computer.

61. The system of claim 59 including:
means for selecting another advertisement from the provided collection of advertisements; and
means for outputting the selected other advertisement.

62. The system of claim 59 means for sending indications of selected advertisements to a server computer.
